(19) United States
(12) Patent Application Publication
(10) Pub. No.: US 2009/0021143 A1
(43) Pub. Date: Jan. 22, 2009

(54) Electron emission device and electron emission type backlight unit comprising the same

(76) Inventors: Yoon-Jin Kim, Suwon-si (KR); Jae-Myung Kim, Suwon-si (KR); Hee-Sung Moon, Suwon-si (KR); Young-Suk Cho, Suwon-so (KR)

Correspondence Address: LEE & MORSE, P.C., 3141 FAIRVIEW PARK DRIVE, SUITE 500, FALLS CHURCH, VA, 22042, US

(21) Appl. No.: 12/216,296

(22) Filed: Jul. 2, 2008

(30) Foreign Application Priority Data
Jul. 19, 2007 (KR) 10-2007-0072469

(51) Int. Cl. H01J 1/62

(52) U.S. Cl. 313/503

(57) ABSTRACT

An electron emission device that includes a first electrode, a second electrode facing the first electrode, and a plurality of electron emission units on a side of the first electrode and electrically connected to the first electrode.

### BACKGROUND OF THE INVENTION

1. Field of the Invention

Embodiments of the present invention relate to an electron emission device, an electron emission type backlight unit including the same, and a method of manufacturing the same. More particularly, embodiments of the present invention relate to an electron emission device that can uniformly emit electrons, an electron emission type backlight unit including the electron emission device, and a method of manufacturing the same.

2. Description of the Related Art

Generally, electron emission devices may be classified into devices using a hot cathode as an electron emission source and devices using a cold cathode as an electron emission source. Examples of electron emission devices using cold cathodes as electron emission sources may include a Field Emission Device (FED), a Surface Conduction Emitter (SCE) device, a Metal Insulator Metal (MIM) device, a Metal Insulator Semiconductor (MIS) device, a Ballistic electron Surface Emitting (BSE) device, and so forth.

FEDs may include a material having a low work function or a high beta function as an electron emission source between electrodes. Application of electric current to the electrodes in a vacuum may cause electron emission due to an electric field difference. Recently, electron emission devices that employ a sharp tip structure mainly formed of Mo or Si, a carbon group material such as graphite or diamond like carbon (DLC), or a nano material such as a nano tube or a nano wire as an electron emission source have been developed.

SCEs are electron emission sources in which a conductive thin film is provided between a first electrode and a second electrode disposed facing each other on a rear substrate, wherein minute gaps or micro-cracks are formed on the conductive thin film. In such SCEs, when electric current is applied to the first and second electrodes, a current flows on a surface of the conductive thin film, and electrons may be emitted from the minute gaps or micro-cracks which are electron emission sources.

In MIM and MIS electron emission devices, electron emission sources having a MIM structure or a MIS structure, respectively, are formed. When electric current is applied between the two metals or between the metal and the semiconductor disposed on either side of the insulator, electrons are moved and accelerated from the metal or the semiconductor having a higher electron potential to the metal having a lower electron potential, and electrons are emitted.

BSE devices use a principle in which, if the size of a semiconductor is reduced to a size smaller than a mean free path of electrons in a semiconductor, the electrons are not dispersed but travel straight. In BSE devices, an electron supply layer made of a metal or a semiconductor is formed on an ohmic electrode, and an insulating layer and a metal thin film are formed on the electron supply layer. When electric current is applied to the ohmic electrode and the metal thin film, electrons are emitted.

A conventional electron emission type backlight unit may include an electron emission unit and a front panel. The front panel may include a front substrate, an anode electrode formed on a lower surface of the front substrate, and a phosphor layer coated on a surface of the anode electrode. An electron emission device of the electron emission unit may include a rear substrate, a first electrode formed in a stripe shape on the rear substrate, a second electrode formed in a stripe shape parallel to the first electrode, and electron emission units disposed around the first electrode and the second electrode. A gap for emitting electrons may be formed between the electron emission units that surround the first electrode and the second electrode. A vacuum space having a pressure lower than atmospheric pressure may be formed between the front panel and the electron emission unit. Spacers spaced at predetermined intervals may be disposed between the front panel and the electron emission unit in order to support the front panel and the electron emission unit from a vacuum state generated therebetween.

In a conventional electron emission device having this type of structure, electrons may be emitted from the electron emission units due to an electric field formed between the first electrode and the second electrode. Electrons are emitted from the electron emission unit that surrounds the first electrode and from the electron emission unit that surrounds the second electrode, with the first and second electrode acting as a cathode. Emitted electrons initially progress towards an electrode that acts as an anode and are accelerated towards the phosphor layer due to a strong electric field induced by the anode electrode.

Materials used for forming the electron emission units in the conventional art are mainly carbon group materials having a large aspect ratio, and thus, many electron emission materials irregularly protrude towards the anode electrode. As a result, the emission of electrons is not controlled by an electric field formed between the first electrode and the second electrode. Moreover, there is a problem of generating a diode discharge by which electrons are emitted from the electron emission material due to an anode electric field formed between an electrode that acts as a cathode and the anode electrode. As an example, when a high voltage is applied to the anode electrode, hot spots or arcs are generated, and thus, it is difficult to achieve a uniform electron emission. Additionally, if the electron emission unit is patterned in a line shape, the entire line shape electron emission unit may be damaged due to an arc generated in this way. Accordingly, there is a need for an electron emission device that can provide uniform electron emission as well as accept high voltage electric current.

### SUMMARY OF THE INVENTION

Embodiments are therefore directed to an electron emission device that may achieve uniform electron emission while accepting high voltage electric current. Embodiments also provide an electron emission type backlight unit to which a high voltage may be applied to an anode electrode and with which a required brightness via the electron emission device may be obtained.

At least one of the above and other features and advantages may be realized by providing an electron emission device, including a first electrode, a second electrode facing the first electrode, and a plurality of electron emission units on a side of the first electrode and electrically connected to the first electrode.

The electron emission units may be between the first electrode and the second electrode. The plurality of electron emission units may be discontinuous on a side of the first electrode. The electron emission device may further include a resistance layer between the electron emission units and the first electrode. The resistance layer may include a material containing amorphous silicon or semiconductor carbon nanotubes.

The electron emission device may further include a gap between the electron emission units and the second electrode. The electron emission units may include a material containing carbide-driven carbon.

At least one of the above and other features and advantages may be realized by providing an electron emission type backlight unit, including a front substrate and a rear substrate facing each other, a plurality of electron emission devices on a surface of the rear substrate, an anode electrode on a surface of the front substrate, and a phosphor layer on a surface of the anode electrode that faces the rear substrate. Each electron emission device may include a plurality of first electrodes at regular intervals in a first direction on the rear substrate, a plurality of second electrodes at regular intervals in the first direction between the first electrodes, and a plurality of electron emission units on sides of the first electrodes and electrically connected to the first electrodes.

The electron emission units may be between the first electrodes and the second electrodes. The electron emission units may be discontinuous on sides of the first electrodes. The electron emission type backlight unit may further include resistance layers between the electron emission units and the first electrodes. The electron emission type backlight may further include gaps between the electron emission units and the second electrodes. The electron emission units may include a material containing carbide-driven carbon.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic, partial cut away perspective view of a configuration of an electron emission device according to an embodiment of the present invention;

FIG. 2 illustrates a schematic, cross-sectional view of a configuration of an electron emission type backlight unit comprising the electron emission device of FIG. 1 according to an embodiment of the present invention; and

FIG. 3 illustrates a plan view of an electron emission unit comprising the electron emission device of FIG. 1 according to an embodiment of the present invention.

### DETAILED DESCRIPTION OF THE INVENTION

Korean Patent Application No. 10-2007-0072469, filed on Jul. 19, 2007, in the Korean Intellectual Property Office, and entitled: “Electron Emission Device and Electron Emission Type Backlight Unit Comprising the Same,” is incorporated by reference herein in its entirety.

The present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

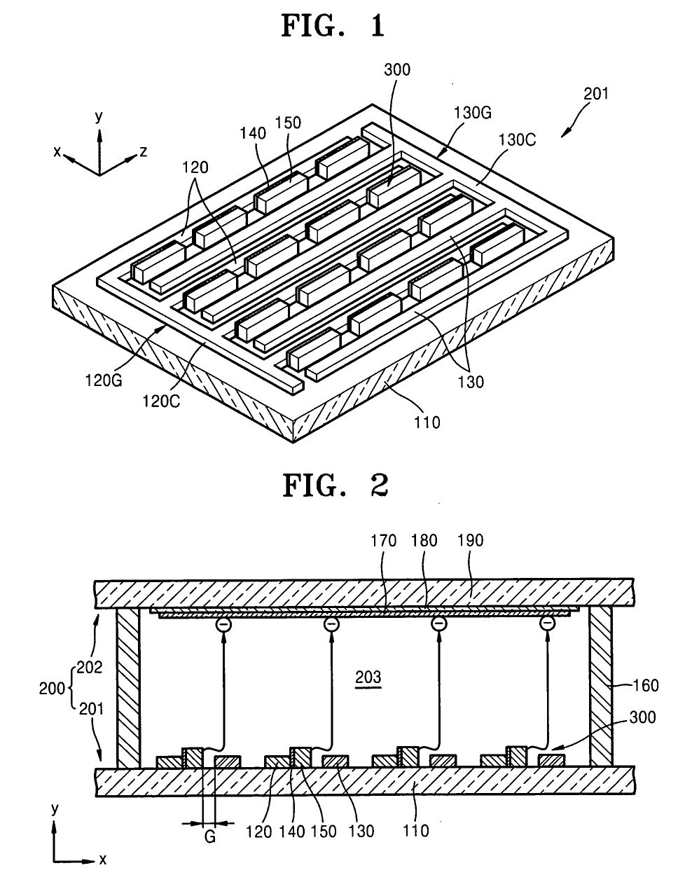

FIG. 1 illustrates a schematic, partial cut away perspective view of a configuration of an electron emission device according to an embodiment of the present invention, and FIG. 2 illustrates a schematic, cross-sectional view of a configuration of an electron emission type backlight unit comprising the electron emission device of FIG. 1 according to an embodiment of the present invention.

Referring to FIGS. 1 and 2, an electron emission device 300 that is part of an electron emission type backlight unit 200 may include a plurality of first electrodes 120, a plurality of second electrodes 130, and a plurality of electron emission units 150 disposed on a rear substrate 110.

The rear substrate 110 may be a plate member having a predetermined thickness, and may be, e.g., quartz glass, glass that contains a small amount of impurity such as Na, glass on which SiO₂ is coated, oxide aluminum, or ceramic. If a flexible display apparatus is to be formed, the rear substrate 110 may be formed of a flexible material.

The first electrodes 120 and the second electrodes 130 may be alternately disposed, may be separated a predetermined distance from each other, may extend in a first direction on the rear substrate 110, e.g., a z-direction, and may be formed of a conventional electrically conductive material. For example, the first electrode 120 and the second electrode 130 may be formed of at least one of Al, Ti, Cr, Ni, Au, Ag, Mo, W, Pt, Cu, and Pd or an alloy of these metals. Also, the first electrode 120 and the second electrode 130 may be formed of at least one metal such as Pd, Ag, RuO₂, or Pd—Ag, or of a printed electric conductor formed of a metal oxide and glass. Also, the first electrode 120 and the second electrode 130 may be formed of a transparent electric conductor such as ITO, In₂O₃, or SnO₂ or a semiconductor material such as polysilicon.

The electron emission units 150 may be formed along a lateral direction of the first electrode 120 so that the electron emission unit 150 may be electrically connected to the first electrode 120, and may be formed of an electron emission material that contains carbide-driven carbon.

The carbide-driven carbon may include a plurality of nano-pores having a diameter of 1 to 1000 nm, and may be formed of carbon. The nano-pores may have an average diameter of 2 to 10 nm. A process of forming the nano-porous carbide-driven carbon will be described below.

If the electron emission unit 150 that includes such carbide-driven carbon is formed on a cathode, and an anode is disposed on a location facing the electron emission unit 150, then electrons may be emitted from the carbide-driven carbon towards the anode. This may be because the nano-sized pores on a surface of the carbide-driven carbon function as electron paths, and this phenomenon may be similar to a point discharge phenomenon by which electrons are emitted from a nano-material having a large aspect ratio such as a nano-tube when an electric field is formed on the nano-material.

Although the carbide-driven carbon may have a completely different structure as compared to the carbon nano-tube, the carbide-driven carbon may have similar characteristics in that electrons are emitted from the carbide-driven carbon when an electric field is formed. A process of forming the carbide-driven carbon will be described later.

Electron emission units 150 may include an electron emission material, for example, a carbon group material or a nano size material. The electron emission units 150 may include at least one of carbon nanotubes, graphite, graphite nanofibers, diamond, diamond-like carbon, fullerene C60, silicon nanowires, and a combination of these materials.

The first electrode 120 may be a cathode electrode that supplies an electric current to the electron emission units 150, and the second electrode 130 may be a gate electrode that forms an electric field around the electron emission units 150 due to a voltage difference with the first electrode 120 to induce electron emission from the electron emission units 150. The electron emission units 150 may be spaced a predetermined distance from the second electrode 130 to avoid an electrical short circuit with the second electrode 130.

The electron emission units 150 may be formed in a continuous line pattern in a lengthwise direction (z-direction) of the first electrode 120 or, as depicted in FIG. 2, may be formed in a discontinuous line pattern in the lengthwise direction of the first electrode 120. If the electron emission unit 150 is a continuous line pattern, the entire continuous line pattern can be damaged by an arc. If, however, the electron emission unit 150 is a discontinuous line pattern, then damage to the entire line may be prevented.

A first connecting electrode 120C may extend in the x-direction and may be disposed on side ends of the first electrodes 120, and the first connecting electrode 120C may constitute a first electrode group 120G together with the first electrodes 120. A second connecting electrode 130C may extend in the x-direction and may be disposed on side ends of the second electrodes 130, and the second connecting electrode 130C may constitute a second electrode group 130G together with the second electrodes 130.

The first electrodes 120 and the second electrodes 130 may be formed on the rear substrate 110 to a height lower than the electron emission units 150. The first electrodes 120 and the second electrodes 130 may be formed using a thin film process such as sputtering or vacuum deposition. Also, the first electrodes 120 and the second electrodes 130 may be formed using a thick film process such as screen printing or laminating.

A resistance layer 140 may further be formed between the electron emission unit 150 and the first electrode 120. The resistance layer 140 may function in reducing an overall voltage level so that a uniform voltage may be applied to the entire region, and may be formed of amorphous silicon or semiconductor carbon nanotube. The resistance layer 140 may also be patterned using the same methods as used for manufacturing the first electrodes 120 and the second electrodes 130 using a thin film process or a thick film process.

In FIG. 1, the electron emission units 150 are shown as being on a side of the first electrodes 120. However, the electron emission units 150 may also be formed on a side of the second electrodes 130 that faces the first electrodes 120. In this case, the electron emission units 150 may not be formed on portions of the side of the second electrodes 130 that directly face portions of the side of the first electrodes 120 where the electron emission units are formed. Instead, the electron emission units 150 may be formed on portions of the side of the second electrodes 130 that do not directly face portions of the side of the first electrodes 120 where the electron emission units are not formed. If the electron emission units 150 are thus configured, the first electrodes 120 and the second electrodes 130 may be operated with interchangeable roles, and thus, the lifespan of the electron emission device 300 may be doubled, or even further extended.

Referring to FIG. 2, the electron emission type backlight unit 200 according to an embodiment of the present invention includes an electron emission type backlight unit 200 that includes a plurality of electron emission devices 300 disposed on the rear substrate 110 and a front panel 202 disposed in front of the electron emission unit 201. The electron emission device 300 has been described above with reference to FIG. 1, and thus, a description thereof will not be repeated.

The front panel 202 includes a front substrate 190 that can transmit visible light, a phosphor layer 170 that is disposed on a lower surface of the front substrate 190 and is excited by electrons emitted from the electron emission device 300 to generate visible light, and an anode electrode 180 that accelerates electrons emitted from the electron emission device 300 towards the phosphor layer 170.

The front substrate 190 may be formed of the same material used to form the rear substrate 110 described above, and may be able to transmit visible light.

The anode electrode 180 may be formed of the same material used to form the first electrodes 120 and the second electrodes 130.

The phosphor layer 170 may be formed of cathode luminescence (CL) type phosphor which is excited by accelerated electrons to generate visible light. The phosphor layer 170 can include various phosphors to emit white light in addition to red, green, and blue lights.

A space 203 between the phosphor layer 170 and the electron emission device 300 may be maintained at a vacuum. For this purpose, spacers 160 that maintain a gap between the phosphor layer 170 and the electron emission device 300 and a glass frit (not shown) that seals the vacuum space 203 may be used. The glass frit functions to seal the vacuum space 203 by surrounding the vacuum space 203.

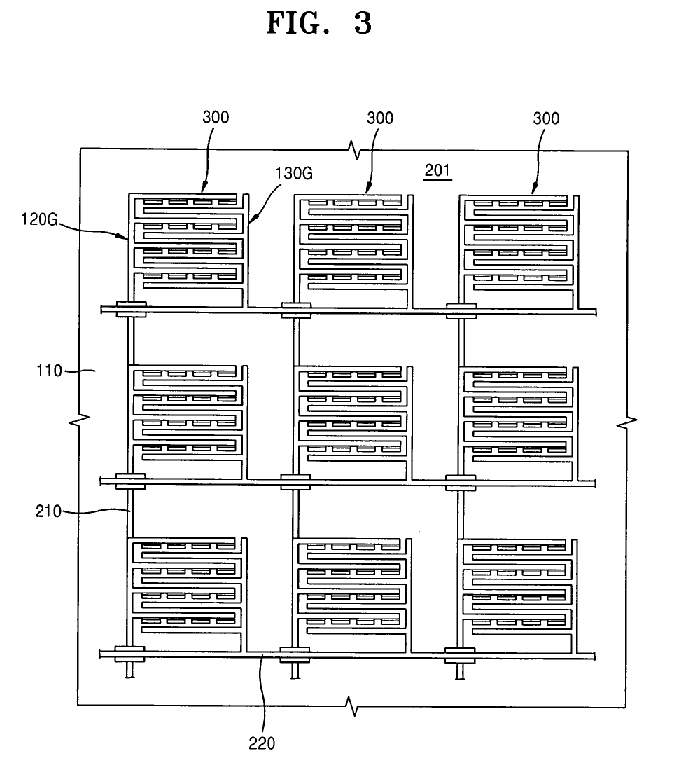

FIG. 3 illustrates a plan view of an electron emission unit comprising the electron emission device 300 of FIG. 1 according to an embodiment of the present invention.

Referring to FIG. 3, a plurality of first electrode groups 120G and a plurality of second electrode groups 130G are formed on a rear substrate 110. The first electrode groups 120G and the second electrode groups 130G that constitute the electron emission devices 300 are electrically connected by a first wire unit 210 extending in a vertical direction and a second wire unit 220 extending in a horizontal direction.

The electron emission type backlight unit 200 having the above structure is operated in the following manner. Referring to FIG. 2, when a negative voltage is applied to the first electrodes 120 and a positive voltage is applied to the second electrodes 130, which are disposed in the electron emission device 300, an electric field is formed between the first electrodes 120 and the second electrodes 130, and thus, due to the electric field formed between the first electrodes 120 and the second electrodes 130, electrons are emitted from the electron emission units 150 towards the second electrodes 130. At this point, when a positive voltage much greater than the positive voltage applied to the second electrodes 130 is applied to the anode electrode 180, the electrons emitted from the electron emission units 150 are accelerated towards the anode electrode 180. The electrons excite the phosphor layer 170 disposed on a lower surface of the anode electrode 180 and the phosphor layer 170 generates visible light. The emission of electrons can be controlled by a voltage applied to the second electrodes 130.

A negative voltage is not necessarily applied to the first electrodes 120, however, all that is needed is the formation of an appropriate potential difference required for emitting electrons between the first electrodes 120 and the second electrodes 130.

The electron emission type backlight unit 200 depicted in FIG. 2 creates surface luminescence and, thus, can be used for a backlight unit of a non-emissive display device such as thin film transistor (TFT)-liquid crystal display (LCD). Also, in order to realize an image, rather than serve merely a surface luminescence to generate visible light, or in order to structure a backlight unit having a dimming function, the first electrodes 120 and the second electrodes 130 of the electron emission device 300 may be disposed to cross each other. In order to have localized dimming, as depicted in FIG. 2, the first electrode group 120G and the second electrode group 130G may be respectively formed in a shape having a main electrode unit and a branch electrode unit. In this case, the first connecting electrode 120C and the second connecting electrode 130C respectively are main electrode units, and the first electrodes 120 and the second electrodes 130 respectively are branch electrode units. The first electrodes 120 and the second electrodes 130, which are branch electrode units, protrude respectively from the first connecting electrode 120C and the second connecting electrode 130C, which are main electrode units, and the first electrodes 120 and the second electrodes 130 are disposed to face each other, and the electron emission units 150 can be formed on sides of the first electrodes 120 or the second electrodes 130, which are branch electrode units.

Referring to FIG. 2, a gap G for emitting electrons is formed between the electron emission unit 150 formed on a side of the first electrode 120 and the second electrode 130. The gap G may have a size of about 5 to 20 micrometers. The gap G may prevent a short circuit between the electron emission unit 150 and the second electrode 130. If the gap G has a size smaller than 5 micrometers, a short circuit may occur, and if the gap G has a size greater than 20 micrometers, the driving voltage may be significantly increased.

Hereinafter, a method of manufacturing an electron emission device according to an embodiment of the present invention will be described. The method of manufacturing an electron emission device according to the present embodiment includes a process of forming an electron emission unit by using an inkjet method or a printing method using a composite for forming the electron emission unit that includes carbide-driven carbon.

In the method of manufacturing an electron emission device, the electron emission unit can be formed by inkjet method or a printing method using a composite for forming the electron emission device as described below. The inkjet method is simple and, thus, manufacturing costs can be greatly reduced when compared to a conventional CVD direct growing method, which has been used for a case in which carbon nanotube is used as a main component of an electron emission unit or a printing method. The printing method is similar to the printing method when conventional carbon nanotubes are used, however, since carbide-driven carbon has a dispersibility that is greater than conventional carbon nanotubes, That is, even though the printing method is used, the process for forming the electron emission unit using the printing process is more simple than the case in which carbon nanotubes are used for forming the electron emission unit.

As an example embodiment, the composite for forming the electron emission unit includes carbide-driven carbon, an organic solvent, and a dispersing agent.

The carbide-driven carbon can be manufactured such that, after a carbide compound is thermo-chemically reacted with a gas that contains a halogen group element, elements except carbon in the carbide compound are extracted. The above process may be performed through operations for (i) forming a workpiece in which carbide compound particles have a predetermined transport porosity, and (ii) manufacturing carbide-driven carbon having a nano-porosity on the entire specimen by extracting remaining elements except carbon in the specimen after the specimen is thermo-chemically treated at a temperature of 350 to 1200° C. in a gas that contains a halogen group element. Details of such a method of forming the carbide-driven carbon are described in Korean Patent Publication No. 20010013225 A, published on Feb. 2, 2001, and in U.S. Pat. No. 7,048,902 B2, issued on May 23, 2006, the entire contents of which are incorporated herein in their entireties and for all purposes.

The carbide-driven carbon is further suitable for forming electron emission units using an inkjet method when compared to a carbon nanotube used for a raw material for forming a conventional electron emission source. This is because the carbon nanotubes have a fiber shape having a large aspect ratio, however, the carbide-driven carbon has a plate shape having a ratio of horizontal length to vertical length is almost 1, that is, a field enhancement factor β is very small. Furthermore, the case of using the carbide-driven carbon has an advantage in that, through a selective application of carbide which is a precursor material for forming an electron emission material, the size of a final electron emission material can be readily controlled.

Preferably, the carbide compound used in the present embodiment is a compound made of carbon with an element of group III, group IV, or group V of the periodic table of elements, and more preferably, can be: a diamond group carbide such as SiC₄, B₄C, or Mo₂C; a metal group carbide such as TiC or ZrCₓ; a salt carbide such as Al₄C₃ or CaC₂; a complex carbide such as TiₓTa_{y}C or MoₓW_{y}C; a carbonitride such as TiNₓC_{y} or ZrNₓC_{y}; or a mixture of the above carbide materials (x and y are both greater than 0 in the above-described carbides). The gas that contains a halogen group element used in the present embodiment may be, e.g., Cl₂ (chlorine), TiCl₄, F₂, Br₂, I₂, HCl, or a mixture of these gases.

A composite for forming the electron emission units may include a dispersing agent, and non-limited examples of the dispersing agents that can be used in the present embodiment include one or more of, e.g., alkyl amine, carboxylic acid amide, and amino carboxylate.

The organic solvent included in the composite for forming the electron emission units can be conventional organic solvents suitable to be used in an inkjet method, and non-limited examples of the organic solvents that can be used in the present embodiment can be: a linear alkane such as hexane, heptane, octane, decane, undecane, dodecane, tridecane, or trimethylpentane; an annular alkane such as cyclohexane, cycloheptane, or cyclooctane; an aromatic hydrocarbon such as benzene, toluene, xylene, trimethyl benzene, or dodecylbenzene; or an alcohol such as hexanol, heptanol, octanol, decanol, cyclohexanol, terpineol, citroneol, geraniol, or phenethyl alcohol, and these organic solvents can be used alone or in a mixed state.

The composite for forming the electron emission units can further include an organic-inorganic binder or an additive, as necessary, in addition to the carbide-driven carbon, the dispersing agent, and the organic solvent.

The composite for forming the electron emission units can be manufactured by mixing a highly dispersed suspension of carbide-driven carbon, a dispersing agent, and an organic solvent with the organic-inorganic binder and other additives and re-stirring them, after the highly dispersed suspension is made by using a conventional method such as mechanically stirring, ultrasonically treating, ball milling, or sand milling. Alternatively, the composite for forming the electron emission units can be manufactured by mixing all constituent ingredients from the outset.

In the present embodiments, since the electron emission units are manufactured using an inkjet method, an additional patterning process is unnecessary, and thus, the process may be simplified, materials saved, and non-uniform emission due to residue generated in a developing process in a conventional printing method can be prevented. In particular, in the present invention, since carbide-driven carbon having a plate type is employed, it is readily applied to an inkjet method, and also, minute electron emission units that generate almost no arc when a high electric field is applied can be easily manufactured.

An electron emission device according to the present embodiments and an electron emission type backlight unit comprising the electron emission device may be effectively manufactured since the process of forming the electron emission units is simple. Since the electron emission units may be formed discontinuously on a side of the first electrode, damage to the entire electron emission units may be prevented.

Also, since the formed carbide-driven carbon thin film layer has high electron emission efficiency, energy consumption of the electron emission device can be reduced and brightness of the electron emission device may be increased. The nano porous carbon (NPC) may exhibit a flat particle shape having an aspect ratio of close to 1, and thus, there is little risk of generating a hot spot or an arc. Also, at the same voltage, the NPC has an emission current density smaller than that of CNT and, thus, has an advantage in view of light emission efficiency of phosphor. Due to the above characteristics of the NPC, a simple structure of the electron emission device proposed in the present invention may be realized.

The present invention may be used in technical fields of electron emission device that emits electrons.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission device, comprising:
a first electrode;
a second electrode facing the first electrode; and
a plurality of electron emission units on a side of the first electrode and electrically connected to the first electrode.

2. The electron emission device as claimed in claim 1, wherein the electron emission units are between the first electrode and the second electrode.

3. The electron emission device as claimed in claim 1, wherein the plurality of electron emission units are discontinuous on a side of the first electrode.

4. The electron emission device as claimed in claim 1, further comprising a resistance layer between the electron emission units and the first electrode.

5. The electron emission device as claimed in claim 4, wherein the resistance layer includes a material containing amorphous silicon or semiconductor carbon nanotubes.

6. The electron emission device as claimed in claim 1, further comprising a gap between the electron emission units and the second electrode.

7. The electron emission device as claimed in claim 1, wherein the electron emission units include a material containing carbide-driven carbon.

8. An electron emission type backlight unit, comprising:
a front substrate and a rear substrate facing each other;
a plurality of electron emission devices on a surface of the rear substrate;
an anode electrode on a surface of the front substrate; and
a phosphor layer on a surface of the anode electrode that faces the rear substrate,
wherein each electron emission device comprises:
a plurality of first electrodes at regular intervals in a first direction on the rear substrate;
a plurality of second electrodes at regular intervals in the first direction between the first electrodes; and
a plurality of electron emission units on sides of the first electrodes and electrically connected to the first electrodes.

9. The electron emission type backlight unit as claimed in claim 8, wherein the electron emission units are between the first electrodes and the second electrodes.

10. The electron emission type backlight unit as claimed in claim 8, wherein the electron emission units are discontinuous on sides of the first electrodes.

11. The electron emission type backlight unit as claimed in claim 8, further comprising resistance layers between the electron emission units and the first electrodes.

12. The electron emission type backlight unit as claimed in claim 8, further comprising gaps between the electron emission units and the second electrodes.

13. The electron emission type backlight unit as claimed in claim 8, wherein the electron emission units include a material containing carbide-driven carbon.
